(19) United States
(12) Patent Application Publication
(10) Pub. No.: US 2025/0245236 A1
(43) Pub. Date: Jul. 31, 2025

(54) SEMANTIC SEARCHING OF STRUCTURED DATA USING GENERATED SUMMARIES

(71) Applicant: Salesforce, Inc., San Francisco, CA (US)

(72) Inventors: Avi Brenner, Phoenix, AZ (US); Ka Man Mary Wong, Vancouver (CA); Vincent Tang, New York, NY (US); Irene Fung, New Westminster (CA)

(21) Appl. No.: 18/427,693

(22) Filed: Jan. 30, 2024

(51) Int. Cl. G06F 16/248; G06F 16/22; G06F 16/25; G06F 40/177; G06F 40/30; G06F 40/40

(52) U.S. Cl. CPC G06F 16/248; G06F 16/2237; G06F 16/258; G06F 40/177; G06F 40/40; G06F 40/30

(57) ABSTRACT

Methods, systems, apparatuses, devices, and computer program products are described. An application server or a data processing system may convert a set of metadata associated with a data object (e.g., document, record, asset) from a first structured format into a second serialized format. The set of metadata in the second serialized (e.g., unstructured) format may be input in a large language model (LLM). The LLM may generate a first natural language summary associated with the data object based on the set of metadata. After receiving a natural language query from a user, the LLM may generate a second natural language summary associated with the data object based on the natural language query. The natural language summaries may be vectorized, and the vectorized versions may be compared. Based on the comparison, an indication of the data object corresponding to the natural language query may be displayed.

### FIELD OF TECHNOLOGY

The present disclosure relates generally to database systems and data processing, and more specifically to semantic searching of structured data using generated summaries.

### BACKGROUND

A cloud platform (i.e., a computing platform for cloud computing) may be employed by multiple users to store, manage, and process data using a shared network of remote servers. Users may develop applications on the cloud platform to handle the storage, management, and processing of data. In some cases, the cloud platform may utilize a multi-tenant database system. Users may access the cloud platform using various user devices (e.g., desktop computers, laptops, smartphones, tablets, or other computing systems, etc.).

In one example, the cloud platform may support customer relationship management (CRM) solutions. This may include support for sales, service, marketing, community, analytics, applications, and the Internet of Things. A user may utilize the cloud platform to help manage contacts of the user. For example, managing contacts of the user may include analyzing data, storing and preparing communications, and tracking opportunities and sales.

The cloud platform may support systems used to perform semantic searches of structured data such as assets (e.g., documents, reports, and the like). In some examples, discovery of assets related to each other may be handled semantically by attempting to match key phrases from existing assets of the user and a query for the relevant assets being searched for. However, as keyword-based searches tend to lose context when searching for structured data such search processes may be complicated for structured data. In addition, semantic searches may rely heavily on specific and guided query phrases from the user. If a user fails to provide specific and clear enough query phrases, the search may yield inaccurate or undesired results.

### BRIEF DESCRIPTION OF THE DRAWINGS

FIG. 1 illustrates an example of a data processing system that supports semantic searching of structured data using generated summaries in accordance with aspects of the present disclosure.

FIG. 2 shows an example of a computing architecture that supports semantic searching of structured data using generated summaries in accordance with aspects of the present disclosure.

FIG. 3 shows an example of an asset indexing process that supports semantic searching of structured data using generated summaries in accordance with aspects of the present disclosure.

FIG. 4 shows an example of an asset discovery process that supports semantic searching of structured data using generated summaries in accordance with aspects of the present disclosure.

FIG. 5 shows an example of a user query process that supports semantic searching of structured data using generated summaries in accordance with aspects of the present disclosure.

FIG. 6 shows an example of a process flow that supports semantic searching of structured data using generated summaries in accordance with aspects of the present disclosure.

FIG. 7 shows a block diagram of an apparatus that supports semantic searching of structured data using generated summaries in accordance with aspects of the present disclosure.

FIG. 8 shows a block diagram of a data processor that supports semantic searching of structured data using generated summaries in accordance with aspects of the present disclosure.

FIG. 9 shows a diagram of a system including a device that supports semantic searching of structured data using generated summaries in accordance with aspects of the present disclosure.

FIGS. 10 through 13 show flowcharts illustrating methods that support semantic searching of structured data using generated summaries in accordance with aspects of the present disclosure.

### DETAILED DESCRIPTION

Some systems may support semantic searching of structured data. In some examples, a set of documents (e.g., assets, reports, and other structured data) may be stored in a data store. The system may receive a query (e.g., from a user) to retrieve a specific document from the data store. As such documents may include significant amounts of data (thus making it inefficient to store them in whole), the documents may be represented by a structured and compact description (e.g., a set of metadata describing the organization and intent of the document). Additionally or alternatively, the data may be stored in a structure format including but not limited to tabular, SQL databases, or spreadsheets. Conventionally, using natural language queries to search for such structured data may be challenging due to the volume of data in the structured format, the lack of contextual information associated with such data, among other reasons.

According to one or more aspects of the present disclosure, a system may utilize generative artificial intelligence (AI) and a large language model (LLM) to process structured documents into unstructured summaries of the documents, which may efficiently enable semantic searching of the structured data. Specifically, each data object or document within a data store may correspond to a set of metadata. The set of metadata may be of a first format (e.g., a structured format), which the system may convert to a second format (e.g., a serialized format) before the set of metadata is input into an LLM. The second serialized format may correspond to an unstructured format (e.g., character strings). Based on inputting the set of metadata in the second serialized format into the LLM, the system may generate a first natural language summary associated with the data object. That is, the first natural language summary may embed or otherwise capture or convey the intent of the structured data (e.g., indicate the organization or content of the document) while using less storage space.

Based on receiving a natural language query (e.g., from a user) and inputting it into the LLM, the system may generate a second natural language query summary corresponding to the data object. That is, while the first natural language summary may be based on the original document itself (via the set of metadata), the second natural language summary may represent a hypothetical document that is likely to correspond to the document that the query is searching for. The system may vectorize and compare the first and second natural language summaries (in a vector-space) to identify a document or other data object closely related to the natural language query. The system may display an indication of the document (or a list of the top most relevant documents based on the vector search space) accordingly, for example, to a user.

Aspects of the disclosure are initially described in the context of an environment supporting an on-demand database service. Aspects of the disclosure are then described in the context of computing architectures, asset indexing processes, asset discovery processes, user query processes, and process flows. Aspects of the disclosure are further illustrated by and described with reference to apparatus diagrams, system diagrams, and flowcharts that relate to semantic searching of structured data using generated summaries.

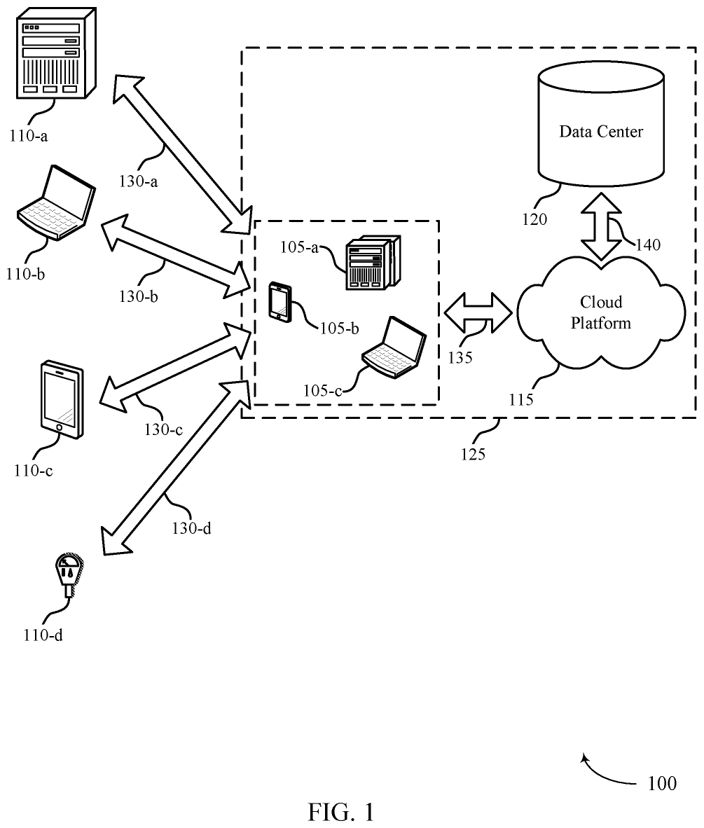

FIG. 1 illustrates an example of a system 100 for cloud computing that supports semantic searching of structured data using generated summaries in accordance with various aspects of the present disclosure. The system 100 includes cloud clients 105, contacts 110, cloud platform 115, and data center 120. Cloud platform 115 may be an example of a public or private cloud network. A cloud client 105 may access cloud platform 115 over network connection 135. The network may implement transfer control protocol and internet protocol (TCP/IP), such as the Internet, or may implement other network protocols. A cloud client 105 may be an example of a user device, such as a server (e.g., cloud client 105-a), a smartphone (e.g., cloud client 105-b), or a laptop (e.g., cloud client 105-c). In other examples, a cloud client 105 may be a desktop computer, a tablet, a sensor, or another computing device or system capable of generating, analyzing, transmitting, or receiving communications. In some examples, a cloud client 105 may be operated by a user that is part of a business, an enterprise, a non-profit, a startup, or any other organization type.

A cloud client 105 may interact with multiple contacts 110. The interactions 130 may include communications, opportunities, purchases, sales, or any other interaction between a cloud client 105 and a contact 110. Data may be associated with the interactions 130. A cloud client 105 may access cloud platform 115 to store, manage, and process the data associated with the interactions 130. In some cases, the cloud client 105 may have an associated security or permission level. A cloud client 105 may have access to certain applications, data, and database information within cloud platform 115 based on the associated security or permission level, and may not have access to others.

Contacts 110 may interact with the cloud client 105 in person or via phone, email, web, text messages, mail, or any other appropriate form of interaction (e.g., interactions 130-a, 130-b, 130-c, and 130-d). The interaction 130 may be a business-to-business (B2B) interaction or a business-to-consumer (B2C) interaction. A contact 110 may also be referred to as a customer, a potential customer, a lead, a client, or some other suitable terminology. In some cases, the contact 110 may be an example of a user device, such as a server (e.g., contact 110-a), a laptop (e.g., contact 110-b), a smartphone (e.g., contact 110-c), or a sensor (e.g., contact 110-d). In other cases, the contact 110 may be another computing system. In some cases, the contact 110 may be operated by a user or group of users. The user or group of users may be associated with a business, a manufacturer, or any other appropriate organization.

Cloud platform 115 may offer an on-demand database service to the cloud client 105. In some cases, cloud platform 115 may be an example of a multi-tenant database system. In this case, cloud platform 115 may serve multiple cloud clients 105 with a single instance of software. However, other types of systems may be implemented, including—but not limited to—client-server systems, mobile device systems, and mobile network systems. In some cases, cloud platform 115 may support CRM solutions. This may include support for sales, service, marketing, community, analytics, applications, and the Internet of Things. Cloud platform 115 may receive data associated with contact interactions 130 from the cloud client 105 over network connection 135, and may store and analyze the data. In some cases, cloud platform 115 may receive data directly from an interaction 130 between a contact 110 and the cloud client 105. In some cases, the cloud client 105 may develop applications to run on cloud platform 115. Cloud platform 115 may be implemented using remote servers. In some cases, the remote servers may be located at one or more data centers 120.

Data center 120 may include multiple servers. The multiple servers may be used for data storage, management, and processing. Data center 120 may receive data from cloud platform 115 via connection 140, or directly from the cloud client 105 or an interaction 130 between a contact 110 and the cloud client 105. Data center 120 may utilize multiple redundancies for security purposes. In some cases, the data stored at data center 120 may be backed up by copies of the data at a different data center (not pictured).

Subsystem 125 may include cloud clients 105, cloud platform 115, and data center 120. In some cases, data processing may occur at any of the components of subsystem 125, or at a combination of these components. In some cases, servers may perform the data processing. The servers may be a cloud client 105 or located at data center 120.

The system 100 may be an example of a multi-tenant system. For example, the system 100 may store data and provide applications, solutions, or any other functionality for multiple tenants concurrently. A tenant may be an example of a group of users (e.g., an organization) associated with a same tenant identifier (ID) who share access, privileges, or both for the system 100. The system 100 may effectively separate data and processes for a first tenant from data and processes for other tenants using a system architecture, logic, or both that support secure multi-tenancy. In some examples, the system 100 may include or be an example of a multi-tenant database system. A multi-tenant database system may store data for different tenants in a single database or a single set of databases. For example, the multi-tenant database system may store data for multiple tenants within a single table (e.g., in different rows) of a database. To support multi-tenant security, the multi-tenant database system may prohibit (e.g., restrict) a first tenant from accessing, viewing, or interacting in any way with data or rows associated with a different tenant. As such, tenant data for the first tenant may be isolated (e.g., logically isolated) from tenant data for a second tenant, and the tenant data for the first tenant may be invisible (or otherwise transparent) to the second tenant. The multi-tenant database system may additionally use encryption techniques to further protect tenant-specific data from unauthorized access (e.g., by another tenant).

Additionally, or alternatively, the multi-tenant system may support multi-tenancy for software applications and infrastructure. In some cases, the multi-tenant system may maintain a single instance of a software application and architecture supporting the software application in order to serve multiple different tenants (e.g., organizations, customers). For example, multiple tenants may share the same software application, the same underlying architecture, the same resources (e.g., compute resources, memory resources), the same database, the same servers or cloud-based resources, or any combination thereof. For example, the system 100 may run a single instance of software on a processing device (e.g., a server, server cluster, virtual machine) to serve multiple tenants. Such a multi-tenant system may provide for efficient integrations (e.g., using application programming interfaces (APIs)) by applying the integrations to the same software application and underlying architectures supporting multiple tenants. In some cases, processing resources, memory resources, or both may be shared by multiple tenants.

As described herein, the system 100 may support any configuration for providing multi-tenant functionality. For example, the system 100 may organize resources (e.g., processing resources, memory resources) to support tenant isolation (e.g., tenant-specific resources), tenant isolation within a shared resource (e.g., within a single instance of a resource), tenant-specific resources in a resource group, tenant-specific resource groups corresponding to a same subscription, tenant-specific subscriptions, or any combination thereof. The system 100 may support scaling of tenants within the multi-tenant system, for example, using scale triggers, automatic scaling procedures, scaling requests, or any combination thereof. In some cases, the system 100 may implement one or more scaling rules to enable relatively fair sharing of resources across tenants. For example, a tenant may have a threshold quantity of processing resources, memory resources, or both to use, which in some cases may be tied to a subscription by the tenant.

In some cases, a device (e.g., any component of subsystem 125, such as a cloud client 105, a server or server cluster associated with the cloud platform 115 or data center 120, etc.) may perform procedures relating to the discovery of document. For example, a data center 120 (e.g., a data store) may store a set of documents or other data objects (e.g., tables, databases, spreadsheets), including reports and other assets. Each document may correspond to a highly-structured, compact description or set of metadata (e.g., a JavaScript Object Notation (JSON) file) that describes the overall intent, scope, and/or content of the document and is much smaller than the document. Because the entire document may be too large to embed and search (e.g., which would lead to excessive resource consumption and searching inefficiencies), the set of metadata may be used for searching. However the limited scope of the set of metadata may limit how much information is available for retrieval.

Specifically, a document or other data objects itself may not be embedded and used for searching because it may be in an incompatible format for an LLM, which may be used to facilitate the searching. For example, the data in the document may be dynamic (e.g., may be changed) and structured (e.g., in a tabular, spreadsheet form). Conversely, LLMs may be trained on unstructured text (e.g., natural language strings) as opposed to tabular or other types of structured data. An LLM trained using unstructured text may be unable to identify a document based on structured text. Thus, embedding the document itself may result in insufficient or failed searches. In addition, the amount of data in the document may be too large to embed meaningfully. Some systems may divide up the document and embed it in portions to describe the larger document. However, this may impact the meaning of the document (e.g., because context may be broken up between portions) and complicate the query language required to retrieve the document.

In contrast, the data processing system 100 may support techniques for semantic searching of structured data using generated summaries. Specifically, the described techniques may support utilizing generative AI (e.g., an LLM or similar model) to process structured documents into unstructured summaries of the documents, which may efficiently enable semantic searching of the structured data. In some examples, each data object or document within a data store may have a corresponding set of metadata also stored. The set of metadata may be of a first structured format, which the system may convert to a second serialized format before the set of metadata is input into an LLM. The second serialized format may correspond to an unstructured format (e.g., character strings). Based on inputting the set of metadata in the second serialized format into the LLM, the system may generate a first natural language summary associated with the data object. That is, the first natural language summary may embed the intent of the structured data (e.g., indicate the organization of the document, the general content or purpose of the document, etc.) while using less storage space.

Based on receiving a natural language query (e.g., from a user) and inputting it into the LLM, the system may generate a second natural language query summary corresponding to the data object. That is, while the first natural language summary may be based on the original document itself (via the set of metadata), the second natural language summary may represent a summary of a hypothetical document or data object that is likely to correspond to the document that the query is searching for. The system may vectorize and compare the first and second natural language summaries (in a vector-space) to identify a document or set of documents that are closely related to the natural language query. The system may display an indication of the document to the user or otherwise transmit or convey an indication to a downstream system or process.

The techniques described herein for semantic searching of structured data using generated summaries may result in one of the following potential improvements. In some examples, the described techniques may improve the accuracy and efficiency of database searching by enabling query-based searches, leveraging an LLM, for data that is inherently structured. As a result, users may engage with a search or discovery process in a natural way without having to rely on specific and accurate keywords in a query. In addition, the described techniques may improve computational efficiency, reduce memory and power usage, and improve the speed and accuracy of querying. For example, the described techniques may support storing and searching structured, compact descriptions (e.g., metadata) of a document rather than an entire document itself, which may reduce memory and power consumption by physically reducing the amount of data being stored. In addition, generating summaries based on these structured, compact descriptions and using the generated summaries for querying may improve computational efficiency based on the summaries being significantly smaller than the documents they represent. The unstructured nature of the generated summaries may improve accuracy and speed of the querying, thus improving user experience.

It should be appreciated by a person skilled in the art that one or more aspects of the disclosure may be implemented in a system 100 to additionally or alternatively solve other problems than those described above. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

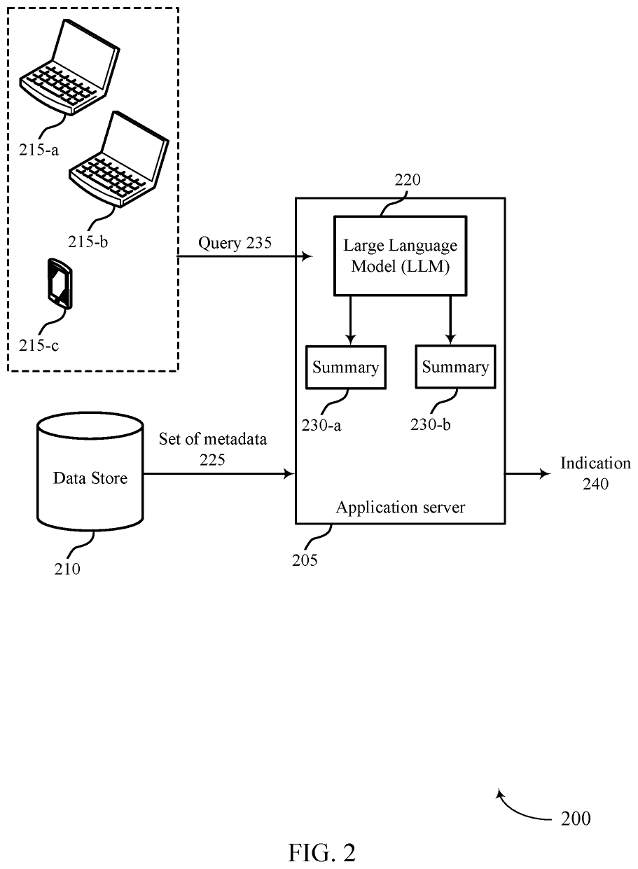

FIG. 2 shows an example of a computing architecture 200 that supports semantic searching of structured data using generated summaries in accordance with aspects of the present disclosure. The computing architecture 200 may include an application server 205 (e.g., a device), a data store 210, and one or more user devices 215 (e.g., user device 215-a, user device 215-b, and user device 215-c), which may be examples of corresponding devices described herein with reference to FIG. 1. In some cases, the functions performed by the application server 205 may instead be performed by a component of the data store 210, the user devices 215, or some other data processing system. In some examples, the application server 205 may support communication with an external server. In addition, the user devices 215 may support an application for semantic searching of structured data, and the user devices 215 in combination with the external server and the application server 205 may support using an LLM 220 to generate summaries and perform the semantic searching of the structured data.

The data store 210 may store a set of documents, including reports, databases, spreadsheets, other types of data objects or assets. Each document or data object may have a corresponding highly-structured, compact description (e.g., a set of metadata 225) that describes a set of attributes associated with the document (e.g., knowledge articles, help files) or a data object. In some cases, the set of metadata 225 may describe the overall intent and organization of the document rather than the data included in the document itself. For example, the set of metadata 225 may include fields corresponding to a uniform resource locator (URL) associated with the document, a short description of the document, a document type, or an owner of the document or corresponding account, among any other numerous fields that may describe the information of the document. In some examples, the set of metadata 225 may be in a first structured format such as a JSON file.

As an LLM may be trained using unstructured data (and thus may process unstructured data more effectively than structured data), a system may convert the set of metadata 225 to a format that is more compatible for ingestion by the LLM (e.g., a second serialized format). The second serialized format may be unstructured (e.g., a string of characters). In some examples, the set of metadata 225 in the second serialized format may be input into the LLM 220, and the LLM 220 may generate a natural language summary 230-a corresponding to the data object. The natural language summary 230-a may be a textual or unstructured summary of the information included in the data object and the set of metadata 225 representing the data object. As such, the LLM may summarize the data object in such a way that the natural language summary 230-a may later be vectorized (e.g., using a word embedding model or similar techniques).

The natural language summary 230-a may, in effect, explain the set of metadata 225 associated with the data object in a meaningful way. In some examples, the natural language summary 230-a may indicate the intent of the report in addition to or instead of simply listing the fields and explicit information included in the set of metadata 225. For example, the natural language summary 230-a may correspond to a document or report titled “Key Management FY22 Method Review,” and may indicate “the Key Mgmt FY22 Method Review report provides a tabular view of program, project, and epic data. It includes details such as project name, health, comments, path to green, communication planned start and end dates, and product owner. The report is filtered and sorted based on specific criteria and includes an aggregate column for record count.” Here, the set of metadata 225 may have included fields or attributes related to the program, project, and epic data, including the project name, and so on. In some examples, the contents of the natural language summary 230-a may include more context than the fields or attributes in the set of metadata 225. In addition, the natural language summary 230-a indicating that “the report is filtered and sorted based on specific criteria” may explain how the document or data object is organized. The natural language summary 230-a may include other types of information and details about the data object and may be presented in various formats.

In some examples, the LLM 220 may generate the natural language summary 230-a based on some prompt. For example, the application server 205 may generate a prompt (e.g., based on a user input) indicating that the set of metadata 225 is being input to the LLM 220 in the second serialized format. In this way, the LLM 220 may be instructed to generate the natural language summary 230-a based on the input set of metadata 225 in the second serialized format.

In some implementations, a user may indicate (e.g., from a user device 215) a natural language query 235 to retrieve a particular data object from the data store 210. The natural language query 235 may be input to the LLM 220, and the LLM 220 may accordingly, generate a natural language summary 230-b corresponding to the data object. As such, where the natural language summary 230-a may be based on the data object itself, the natural language summary 230-b may represent a hypothetical summary of a hypothetical report that may answer the natural language query 235 from the user. Put another way, the LLM 220 may use the natural language query 235 to identify features of a document or report that the user is likely searching for.

When the natural language summaries 230 are generated, the application server 205 may use AI embedding models to index the data objects of interest into vectors and ultimately store the vectors in a vector database. For example, the application server 205 may generate a vectorized version of the natural language summary 230-a and a vectorized version of the natural language summary 230-b using an embedding model. As such, the application server 205 may index each data object of interest and store the vectorized version of the natural language summaries 230 in a vector store or vector database.

In some examples, application server 205 may perform a vector-space comparison of the vectorized versions of the natural language summaries 230 to identify a data object from the data store 210 that corresponds to the natural language query 235. In some examples, the vector-space comparison may include measuring a distance between the vectorized natural language summary 230-a and the vectorized version of the natural language summary 230-b. In this way, the application server 205 may mathematically compare properties of the vectors to determine semantic similarities between the natural language summaries 230 and thus, between structured data objects within the data store 210.

In some implementations, the application server 205 may perform a ranking procedure to rank a set of vector distances (e.g., between the vectorized natural language summary 230-a and one or more natural language summaries 230 generated based on a natural language query 235). The ranking may indicate an accuracy of the natural language summaries 230 based on semantic scores provided by the vector store or database. For example, a higher ranking may indicate that the natural language summary 230-b is more similar to the natural language summary 230-a, and thus, may result in highly-accurate search results for a corresponding document. In some examples, the application server 205 may display an indication 240 of a data object that is related to the natural language query 235 based on the vector-space comparison. That is, the application server 205 may use the vector-space comparison to identify and output an indication of the data object being searched for via the natural language query 235.

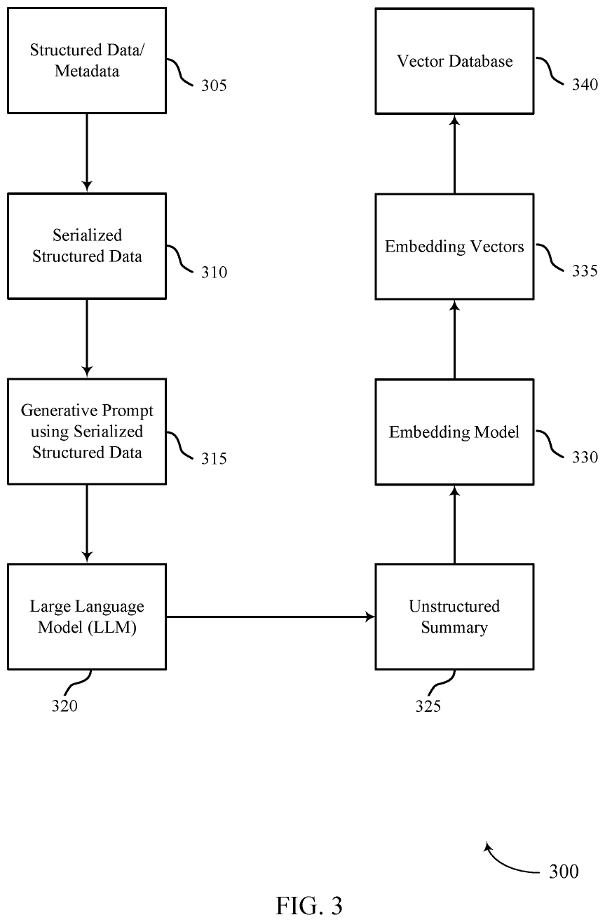

FIG. 3 shows an example of an asset indexing process 300 that supports semantic searching of structured data using generated summaries in accordance with aspects of the present disclosure. The asset indexing process 300 may implement or be implemented by aspects of the data processing system 100 and the computing architecture 200. For example, the asset indexing process 300 may indicate a process used to index (e.g., offline index) the data objects (e.g., assets, documents) of interest into vectors and ultimately store the vectors in a vector database.

At 305, one or more data objects (e.g., documents, reports, assets) may be stored in a data store. A data object may be represented by a set of metadata in a first structured format (e.g., a JSON file, tabular form). For example, the set of metadata may indicate fields or attributes associated with the data object and an organization of the data object, among other information.

At 310, the structured set of metadata may be converted from the first structured format to a second serialized format (e.g., using a serialization procedure). For example, the set of metadata may be converted from a JSON file to a character string, which may be input into an LLM.

At 315, an application server (e.g., supporting a data processing system) may generate a prompt indicating that the set of metadata is being input to an LLM in the second serialized format. That is, the prompt may indicate what the LLM is to generate using the set of metadata in the second serialized format as an input.

At 320, based on the generative prompt, the set of metadata may be input to the LLM in the second serialized format. The LLM may be trained on unstructured data, and as such, may be able to use the set of metadata (which is also in an unstructured format).

At 325, the LLM may generate a first natural language summary based on inputting the set of metadata in the second serialized format into the LLM. In some examples, the first natural language summary may be a summary of the details and information included in the set of metadata based on the set of metadata itself (and thus, the actual data object).

At 330, 335, and 340, the application server may use an embedding model to generate a vectorized version of the first natural language summary (e.g., an embedding vector). The embedding model may embed the intent or meaning of the data object into an embedding vector, which may be stored in a vector database. In this way, each natural language summary generated by the LLM may be vectorized and embedded for comparison to future generated natural language summaries.

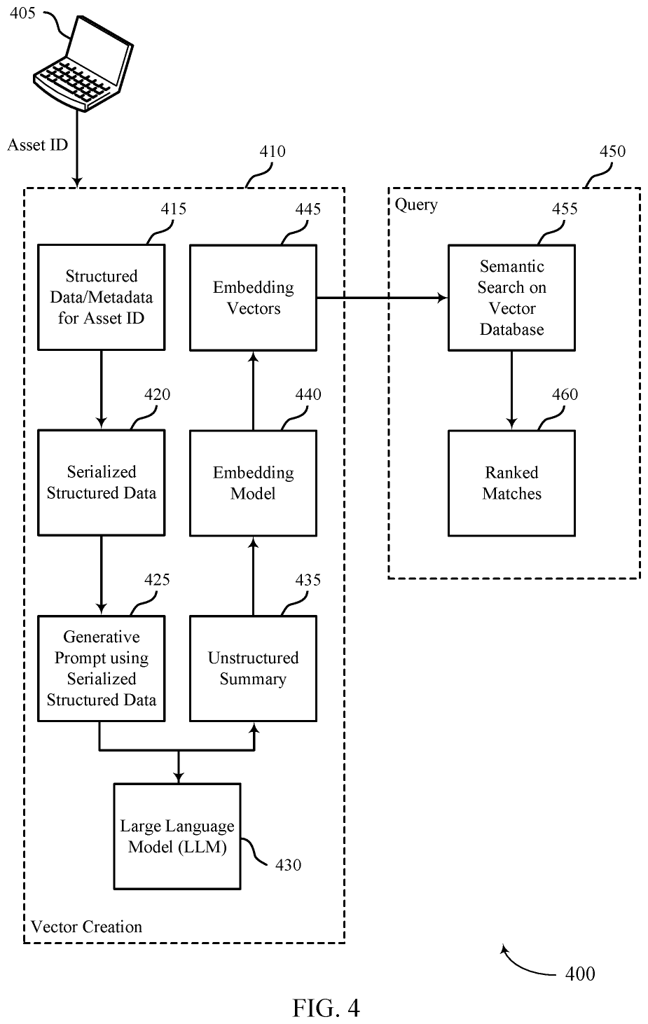

FIG. 4 shows an example of an asset discovery process 400 that supports semantic searching of structured data using generated summaries in accordance with aspects of the present disclosure. The asset discovery process 400 may implement or be implemented by aspects of the data processing system 100 and the computing architecture 200. For example, the asset discovery process 400 may indicate a process performed at runtime to match specific assets with similar existing assets.

In some examples, a user may indicate (e.g., via a user device 405) an asset identifier (ID), which may correspond to an asset (e.g., a document, a report) in a data store which a user may attempt to retrieve using a natural language query.

At 415, an application server (e.g., supporting a data processing system) may identify a set of metadata associated with a data object corresponding to the asset ID based on the indication from the user. In some examples, the set of metadata may be identified as a part of a vector creation process 410. The set of metadata may be of a first structured format (e.g., a JSON file, tabular form). For example, the set of metadata may indicate fields or attributes associated with the data object and an organization of the data object, among other information.

At 420, the structured set of metadata may be converted from the first structured format to a second serialized format (e.g., using a serialization procedure). For example, the set of metadata may be converted from a JSON file to a character string, which may be input into an LLM.

At 425, the application may generate a prompt indicating that the set of metadata is being input to an LLM in the second serialized format. That is, the prompt may indicate what the LLM is to generate using the set of metadata in the second serialized format as an input.

At 430, based on the generative prompt, the set of metadata may be input to the LLM in the second serialized format. The LLM may be trained on unstructured data, and as such, may be able to use the set of metadata (which is also in an unstructured format).

At 435, the LLM may generate a first natural language summary based on inputting the set of metadata in the second serialized format into the LLM. In some examples, the first natural language summary may be a summary of the details and information included in the set of metadata based on the set of metadata itself (and thus, the actual data object).

At 440 and 445, the application server may use an embedding model to generate a vectorized version of the first natural language summary (e.g., an embedding vector). The embedding model may embed the intent or meaning of the data object into an embedding vector, which may be stored in a vector database. In this way, each natural language summary generated by the LLM may be vectorized and embedded for comparison to future generated natural language summaries.

In some examples, the vectorized natural language summaries may be used in a query process 450. At 455, a user may perform a semantic search on the vector database to identify a natural language summary and corresponding data object associated with a natural language query.

At 460, the application server may perform a ranking procedure to rank the embedded vectors based on a distance between each vectorized natural language summary in the vector space. The ranking procedure may enable the user to identify the most accurate data object that is being queried. As such, the user may perform a query search based on existing assets to find similar assets.

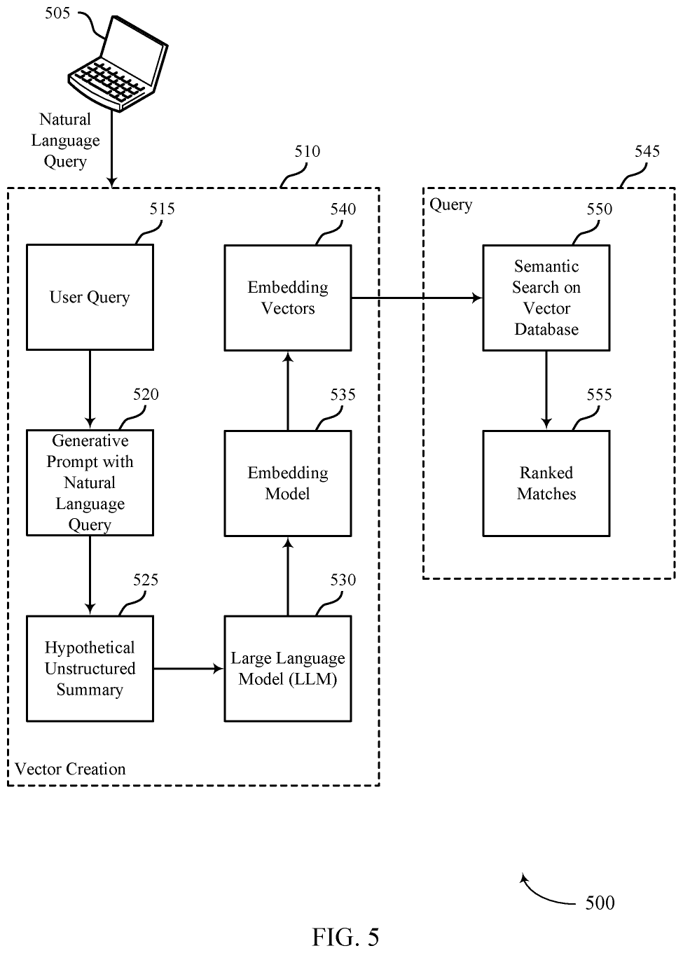

FIG. 5 shows an example of a user query process 500 that supports semantic searching of structured data using generated summaries in accordance with aspects of the present disclosure. The user query process 500 may implement or be implemented by aspects of the data processing system 100 and the computing architecture 200. For example, the user query process 500 may indicate a process performed at runtime to match a natural language query from a user with similar existing assets by creating an unstructured summary for a hypothetical asset based on the natural language query.

At 515, an application server (e.g., supporting a data processing system) may receive a natural language query from a user via a user device 505. In some examples, the user may transmit the natural language query during a vector creation process 510. The natural language query may be unstructured.

At 520, the application may generate a prompt indicating that the natural language query is being input to an LLM (e.g., in an unstructured format). That is, the prompt may indicate what the LLM is to generate using the natural language query as an input.

At 525, based on the generative prompt, the natural language query may be input to the LLM, where the LLM may be trained on unstructured data. In some examples, the LLM may generate a natural language summary based on inputting the natural language query. The natural language summary may be a hypothetical, unstructured report summary corresponding to a hypothetical data object that would likely be retrieved based on the natural language query.

At 530, 535, and 540, the application server may use an LLM and an embedding model to generate a vectorized version of the natural language summary (e.g., an embedding vector). The embedding model may embed the intent or meaning of the data object into an embedding vector, which may be stored in a vector database. In this way, each natural language summary generated by the LLM may be vectorized and embedded for comparison to future generated natural language summaries.

In some examples, the vectorized natural language summaries may be used in a query process 545. At 550, a user may perform a semantic search on the vector database to identify a natural language summary and corresponding data object associated with a natural language query.

At 555, the application server may perform a ranking procedure to rank the embedded vectors based on a distance between each vectorized natural language summary in the vector space. The ranking procedure may enable the user to identify the most accurate data object that is being queried.

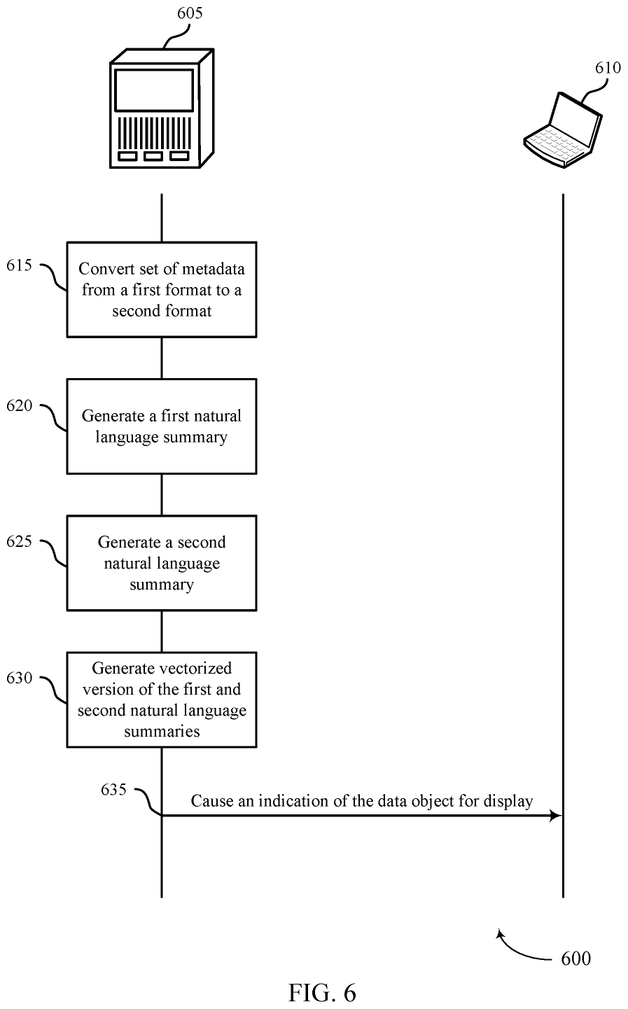

FIG. 6 shows an example of a process flow 600 that supports semantic searching of structured data using generated summaries in accordance with aspects of the present disclosure. The process flow 600 may implement or be implemented by aspects of the data processing system 100 or the computing architecture 200. For example, the process flow 600 may include an application server 605 and a user device 610, which may be examples of corresponding services and platforms described herein. In the following description of the process flow 600, operations between the application server 605 and the user device 610 may be performed in a different order or at a different time than as shown. Additionally, or alternatively, some operations may be omitted from the process flow 600, and other operations may be added to the process flow 600. The process flow 600 may support techniques for semantic searching of structured data using generated summaries.

At 615, the application server 605 may convert a set of metadata from a first structured format to a second serialized format, where the set of metadata corresponds to a data object within a data store. The first structured format may be an example of a structured data object that represents other data (e.g., a JSON file), and the second serialized format may be an unstructured, textual format. In some examples, the data object may correspond to a document, a record, or an asset.

At 620, the application server 605 may generate a first natural language summary corresponding to the data object by inputting the set of metadata in the second serialized format into an LLM. The first natural language summary may indicate information and details of the data object and the organization of the data object, which may be used for searching the data store.

At 625, the application server 605 may generate a second natural language summary corresponding to the data object based on inputting a natural language query for the data object into the LLM. For example, the application server 605 may receive the natural language query from a user (e.g., via the user device 610) and input the natural language query into the LLM. As such, the second natural language summary may indicate a hypothetical report summary corresponding to a hypothetical data object associated with the natural language query.

At 630, the application server 605 may generate a vectorized version of the first natural language summary and a vectorized version of the second natural language summary using an embedding model. The application server 605 may perform a vector-space comparison of the vectorized versions of the first and second natural language summaries to determine a similarity between the summaries. In some examples, to perform the vector-space comparison, the application server 205 may measure a distance between the vectorized versions of the first and second natural language summaries.

At 635, the application server 605 may cause for display an indication of the data object as related to the natural language query based on the vector-space comparison. The data object may be identified based on similarity (and accuracy) of the second natural language summary.

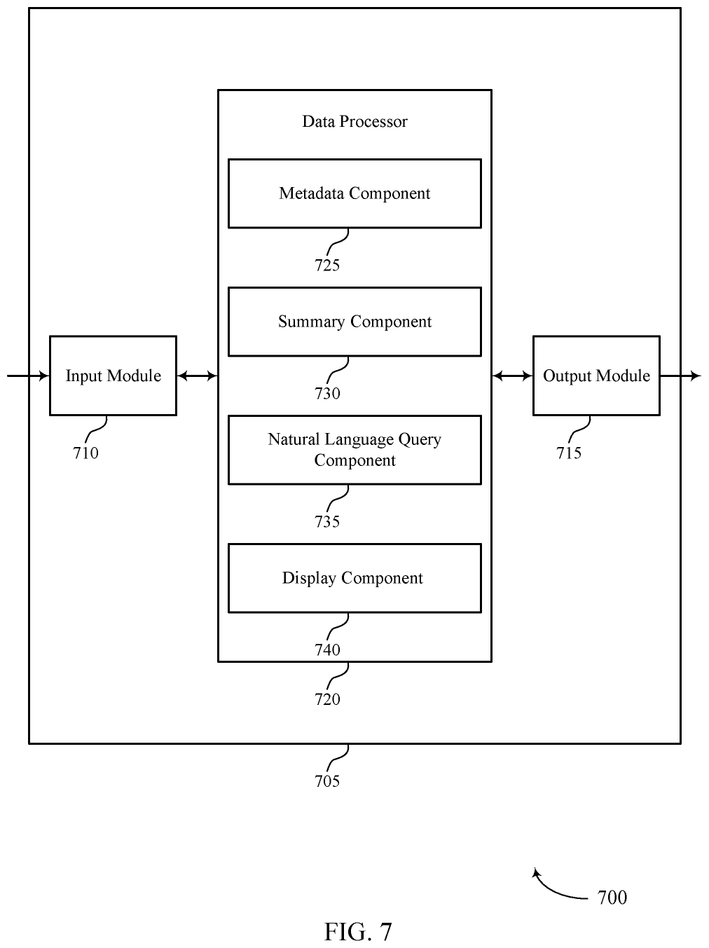

FIG. 7 shows a block diagram 700 of a device 705 that supports semantic searching of structured data using generated summaries in accordance with aspects of the present disclosure. The device 705 may include an input module 710, an output module 715, and a data processor 720. The device 705, or one or more components of the device 705 (e.g., the input module 710, the output module 715, the data processor 720), may include at least one processor, which may be coupled with at least one memory, to support the described techniques. Each of these components may be in communication with one another (e.g., via one or more buses).

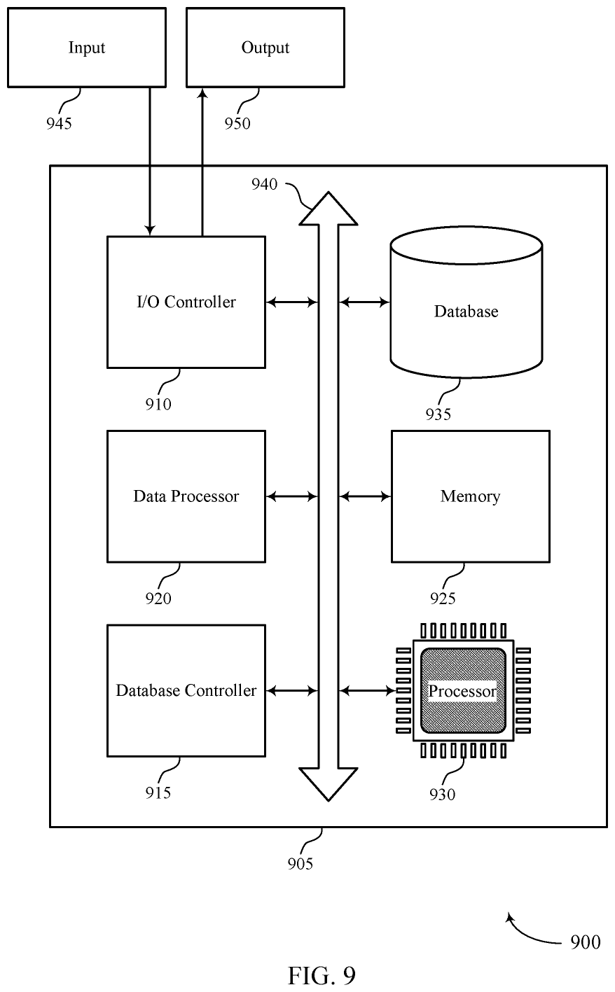

The input module 710 may manage input signals for the device 705. For example, the input module 710 may identify input signals based on an interaction with a modem, a keyboard, a mouse, a touchscreen, or a similar device. These input signals may be associated with user input or processing at other components or devices. In some cases, the input module 710 may utilize an operating system such as iOS®, ANDROID®, MS-DOS®, MS-WINDOWS®, OS/2®, UNIX®, LINUX®, or another known operating system to handle input signals. The input module 710 may send aspects of these input signals to other components of the device 705 for processing. For example, the input module 710 may transmit input signals to the data processor 720 to support semantic searching of structured data using generated summaries. In some cases, the input module 710 may be a component of an input/output (I/O) controller 910 as described with reference to FIG. 9.

The output module 715 may manage output signals for the device 705. For example, the output module 715 may receive signals from other components of the device 705, such as the data processor 720, and may transmit these signals to other components or devices. In some examples, the output module 715 may transmit output signals for display in a user interface, for storage in a database or data store, for further processing at a server or server cluster, or for any other processes at any number of devices or systems. In some cases, the output module 715 may be a component of an I/O controller 910 as described with reference to FIG. 9.

For example, the data processor 720 may include a metadata component 725, a summary component 730, a natural language query component 735, a display component 740, or any combination thereof. In some examples, the data processor 720, or various components thereof, may be configured to perform various operations (e.g., receiving, monitoring, transmitting) using or otherwise in cooperation with the input module 710, the output module 715, or both. For example, the data processor 720 may receive information from the input module 710, send information to the output module 715, or be integrated in combination with the input module 710, the output module 715, or both to receive information, transmit information, or perform various other operations as described herein.

The data processor 720 may support data processing in accordance with examples as disclosed herein. The metadata component 725 may be configured to support converting a set of metadata from a first structured format to a second serialized format, where the set of metadata corresponds to a data object within a data store. The summary component 730 may be configured to support generating a first natural language summary corresponding to the data object by inputting the set of metadata in the second serialized format into a LLM. The natural language query component 735 may be configured to support generating a second natural language summary corresponding to the data object by inputting a natural language query for the data object into the LLM. The display component 740 may be configured to support causing for display an indication of the data object as being related to the natural language query based on vector-space comparison of a vectorized version of the first natural language summary and a vectorized version of the second natural language summary.

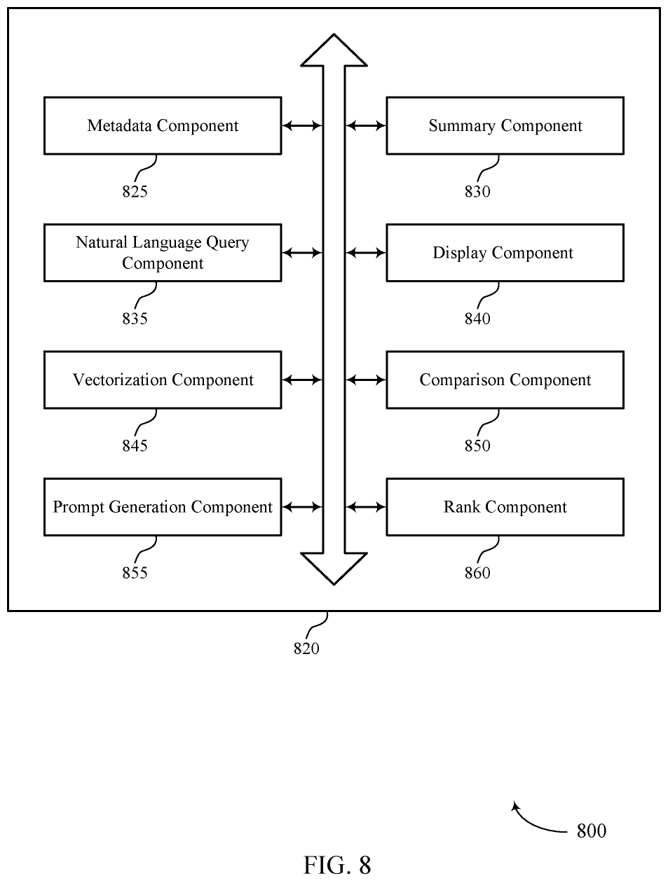

FIG. 8 shows a block diagram 800 of a data processor 820 that supports semantic searching of structured data using generated summaries in accordance with aspects of the present disclosure. The data processor 820 may be an example of aspects of a data processor or a data processor 720, or both, as described herein. The data processor 820, or various components thereof, may be an example of means for performing various aspects of semantic searching of structured data using generated summaries as described herein. For example, the data processor 820 may include a metadata component 825, a summary component 830, a natural language query component 835, a display component 840, a vectorization component 845, a comparison component 850, a prompt generation component 855, a rank component 860, or any combination thereof. Each of these components, or components of subcomponents thereof (e.g., one or more processors, one or more memories), may communicate, directly or indirectly, with one another (e.g., via one or more buses).

The data processor 820 may support data processing in accordance with examples as disclosed herein. The metadata component 825 may be configured to support converting a set of metadata from a first structured format to a second serialized format, where the set of metadata corresponds to a data object within a data store. The summary component 830 may be configured to support generating a first natural language summary corresponding to the data object by inputting the set of metadata in the second serialized format into a LLM. The natural language query component 835 may be configured to support generating a second natural language summary corresponding to the data object by inputting a natural language query for the data object into the LLM. The display component 840 may be configured to support causing for display an indication of the data object as being related to the natural language query based on vector-space comparison of a vectorized version of the first natural language summary and a vectorized version of the second natural language summary.

In some examples, the vectorization component 845 may be configured to support generating the vectorized version of the first natural language summary and the vectorized version of the second natural language summary using an embedding model.

In some examples, to support causing for display, the indication of the data object, the comparison component 850 may be configured to support performing the vector-space comparison based on measuring a distance between the vectorized version of the first natural language summary and the vectorized version of the second natural language summary.

In some examples, to support performing the vector-space comparison, the rank component 860 may be configured to support performing a ranking procedure to rank a set of multiple vector distances.

In some examples, to support generating the first natural language summary, the prompt generation component 855 may be configured to support generating a prompt indicating that the set of metadata is in the second serialized format for the LLM, where the first natural language summary is generated in accordance with the prompt.

In some examples, the vectorization component 845 may be configured to support storing the vectorized version of the first natural language summary in a vector database. In some examples, the second natural language summary corresponds to a hypothetical data object related to the natural language query.

In some examples, the set of metadata in the first structured format indicates a set of multiple attributes associated with the data object. In some examples, generating the first natural language summary is based on the set of multiple attributes. In some examples, the data object includes structured data (e.g., tabular form).

FIG. 9 shows a diagram of a system 900 including a device 905 that supports semantic searching of structured data using generated summaries in accordance with aspects of the present disclosure. The device 905 may be an example of or include components of a device 705 as described herein. The device 905 may include components for bi-directional data communications including components for transmitting and receiving communications, such as a data processor 920, an I/O controller, such as an I/O controller 910, a database controller 915, at least one memory 925, at least one processor 930, and a database 935. These components may be in electronic communication or otherwise coupled (e.g., operatively, communicatively, functionally, electronically, electrically) via one or more buses (e.g., a bus 940).

The I/O controller 910 may manage input signals 945 and output signals 950 for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. In other cases, the I/O controller 910 may represent or interact with a modem, a keyboard, a mouse, a touchscreen, or a similar device. In some cases, the I/O controller 910 may be implemented as part of a processor 930. In some examples, a user may interact with the device 905 via the I/O controller 910 or via hardware components controlled by the I/O controller 910.

The database controller 915 may manage data storage and processing in a database 935. In some cases, a user may interact with the database controller 915. In other cases, the database controller 915 may operate automatically without user interaction. The database 935 may be an example of a single database, a distributed database, multiple distributed databases, a data store, a data lake, or an emergency backup database.

Memory 925 may include random-access memory (RAM) and read-only memory (ROM). The memory 925 may store computer-readable, computer-executable software including instructions that, when executed, cause at least one processor 930 to perform various functions described herein. In some cases, the memory 925 may contain, among other things, a basic I/O system (BIOS) which may control basic hardware or software operation such as the interaction with peripheral components or devices. The memory 925 may be an example of a single memory or multiple memories. For example, the device 905 may include one or more memories 925.

The processor 930 may include an intelligent hardware device (e.g., a general-purpose processor, a digital signal processor (DSP), a central processing unit (CPU), a microcontroller, an application-specific integrated circuit (ASIC), a field-programmable gate array (FPGA), a programmable logic device, a discrete gate or transistor logic component, a discrete hardware component, or any combination thereof). In some cases, the processor 930 may be configured to operate a memory array using a memory controller. In other cases, a memory controller may be integrated into the processor 930. The processor 930 may be configured to execute computer-readable instructions stored in at least one memory 925 to perform various functions (e.g., functions or tasks supporting semantic searching of structured data using generated summaries). The processor 930 may be an example of a single processor or multiple processors. For example, the device 905 may include one or more processors 930.

The data processor 920 may support data processing in accordance with examples as disclosed herein. For example, the data processor 920 may be configured to support converting a set of metadata from a first structured format to a second serialized format, where the set of metadata corresponds to a data object within a data store. The data processor 920 may be configured to support generating a first natural language summary corresponding to the data object by inputting the set of metadata in the second serialized format into a LLM. The data processor 920 may be configured to support generating a second natural language summary corresponding to the data object by inputting a natural language query for the data object into the LLM. The data processor 920 may be configured to support causing for display an indication of the data object as being related to the natural language query based on vector-space comparison of a vectorized version of the first natural language summary and a vectorized version of the second natural language summary.

By including or configuring the data processor 920 in accordance with examples as described herein, the device 905 may support techniques for semantic searching of structured data using generated summaries, which may improve computational efficiency, reduce memory and power consumption, improve querying accuracy and speed, and improve user experience.

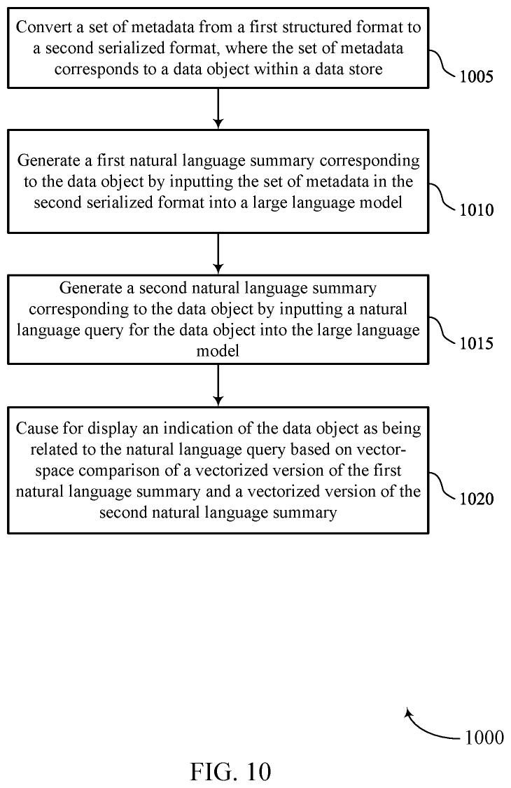

FIG. 10 shows a flowchart illustrating a method 1000 that supports semantic searching of structured data using generated summaries in accordance with aspects of the present disclosure. The operations of the method 1000 may be implemented by a data processor or its components as described herein. For example, the operations of the method 1000 may be performed by a data processor as described with reference to FIGS. 1 through 9. In some examples, a data processor may execute a set of instructions to control the functional elements of the data processor to perform the described functions. Additionally, or alternatively, the data processor may perform aspects of the described functions using special-purpose hardware.

At 1005, the method may include converting a set of metadata from a first structured format to a second serialized format, where the set of metadata corresponds to a data object within a data store. The operations of 1005 may be performed in accordance with examples as disclosed herein. In some examples, aspects of the operations of 1005 may be performed by a metadata component 825 as described with reference to FIG. 8.

At 1010, the method may include generating a first natural language summary corresponding to the data object by inputting the set of metadata in the second serialized format into a LLM. The operations of 1010 may be performed in accordance with examples as disclosed herein. In some examples, aspects of the operations of 1010 may be performed by a summary component 830 as described with reference to FIG. 8.

At 1015, the method may include generating a second natural language summary corresponding to the data object by inputting a natural language query for the data object into the LLM. The operations of 1015 may be performed in accordance with examples as disclosed herein. In some examples, aspects of the operations of 1015 may be performed by a natural language query component 835 as described with reference to FIG. 8.

At 1020, the method may include causing for display an indication of the data object as being related to the natural language query based on vector-space comparison of a vectorized version of the first natural language summary and a vectorized version of the second natural language summary. The operations of 1020 may be performed in accordance with examples as disclosed herein. In some examples, aspects of the operations of 1020 may be performed by a display component 840 as described with reference to FIG. 8.

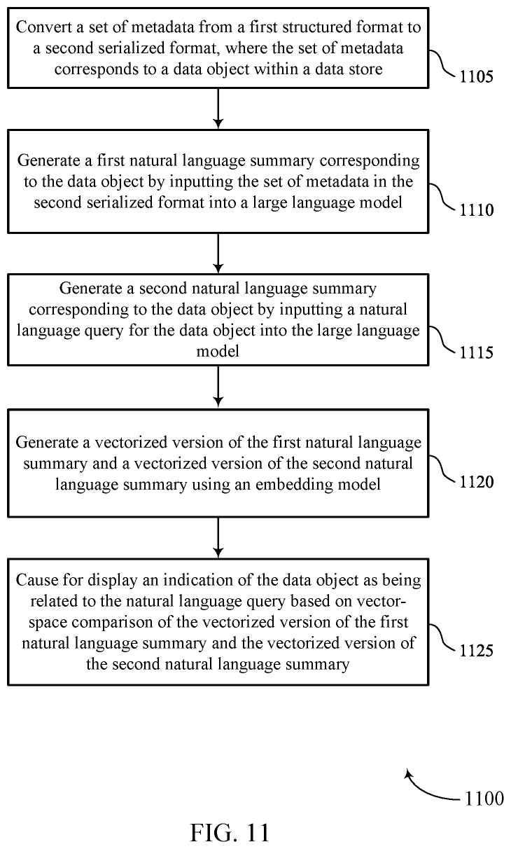

FIG. 11 shows a flowchart illustrating a method 1100 that supports semantic searching of structured data using generated summaries in accordance with aspects of the present disclosure. The operations of the method 1100 may be implemented by a data processor or its components as described herein. For example, the operations of the method 1100 may be performed by a data processor as described with reference to FIGS. 1 through 9. In some examples, a data processor may execute a set of instructions to control the functional elements of the data processor to perform the described functions. Additionally, or alternatively, the data processor may perform aspects of the described functions using special-purpose hardware.

At 1105, the method may include converting a set of metadata from a first structured format to a second serialized format, where the set of metadata corresponds to a data object within a data store. The operations of 1105 may be performed in accordance with examples as disclosed herein. In some examples, aspects of the operations of 1105 may be performed by a metadata component 825 as described with reference to FIG. 8.

At 1110, the method may include generating a first natural language summary corresponding to the data object by inputting the set of metadata in the second serialized format into a LLM. The operations of 1110 may be performed in accordance with examples as disclosed herein. In some examples, aspects of the operations of 1110 may be performed by a summary component 830 as described with reference to FIG. 8.

At 1115, the method may include generating a second natural language summary corresponding to the data object by inputting a natural language query for the data object into the LLM. The operations of 1115 may be performed in accordance with examples as disclosed herein. In some examples, aspects of the operations of 1115 may be performed by a natural language query component 835 as described with reference to FIG. 8.

At 1120, the method may include generating a vectorized version of the first natural language summary and a vectorized version of the second natural language summary using an embedding model. The operations of 1120 may be performed in accordance with examples as disclosed herein. In some examples, aspects of the operations of 1120 may be performed by a vectorization component 845 as described with reference to FIG. 8.

At 1125, the method may include causing for display an indication of the data object as being related to the natural language query based on vector-space comparison of the vectorized version of the first natural language summary and the vectorized version of the second natural language summary. The operations of 1125 may be performed in accordance with examples as disclosed herein. In some examples, aspects of the operations of 1125 may be performed by a display component 840 as described with reference to FIG. 8.

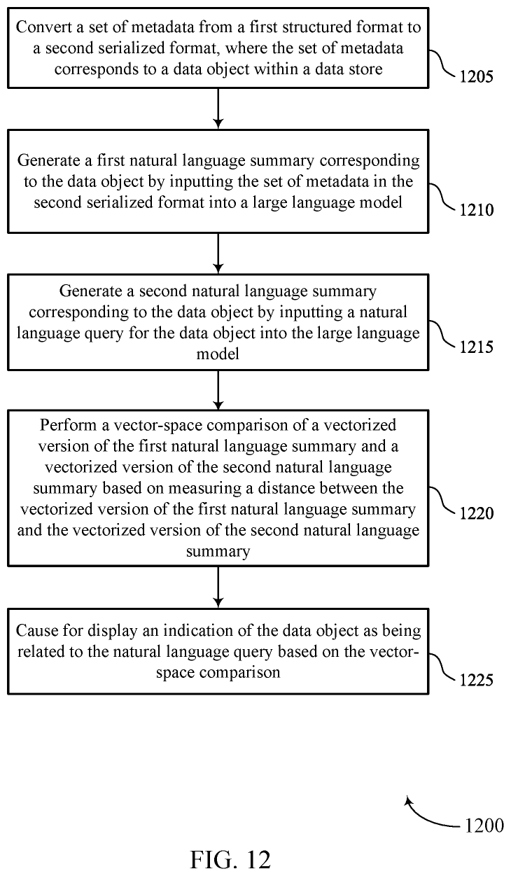

FIG. 12 shows a flowchart illustrating a method 1200 that supports semantic searching of structured data using generated summaries in accordance with aspects of the present disclosure. The operations of the method 1200 may be implemented by a data processor or its components as described herein. For example, the operations of the method 1200 may be performed by a data processor as described with reference to FIGS. 1 through 9. In some examples, a data processor may execute a set of instructions to control the functional elements of the data processor to perform the described functions. Additionally, or alternatively, the data processor may perform aspects of the described functions using special-purpose hardware.

At 1205, the method may include converting a set of metadata from a first structured format to a second serialized format, where the set of metadata corresponds to a data object within a data store. The operations of 1205 may be performed in accordance with examples as disclosed herein. In some examples, aspects of the operations of 1205 may be performed by a metadata component 825 as described with reference to FIG. 8.

At 1210, the method may include generating a first natural language summary corresponding to the data object by inputting the set of metadata in the second serialized format into a LLM. The operations of 1210 may be performed in accordance with examples as disclosed herein. In some examples, aspects of the operations of 1210 may be performed by a summary component 830 as described with reference to FIG. 8.

At 1215, the method may include generating a second natural language summary corresponding to the data object by inputting a natural language query for the data object into the LLM. The operations of 1215 may be performed in accordance with examples as disclosed herein. In some examples, aspects of the operations of 1215 may be performed by a natural language query component 835 as described with reference to FIG. 8.

At 1220, the method may include performing a vector-space comparison a vectorized version of the first natural language summary and a vectorized version of the second natural language summary based on measuring a distance between the vectorized version of the first natural language summary and the vectorized version of the second natural language summary. The operations of 1220 may be performed in accordance with examples as disclosed herein. In some examples, aspects of the operations of 1220 may be performed by a comparison component 850 as described with reference to FIG. 8.

At 1225, the method may include causing for display an indication of the data object as being related to the natural language query based on the vector-space comparison. The operations of 1225 may be performed in accordance with examples as disclosed herein. In some examples, aspects of the operations of 1225 may be performed by a display component 840 as described with reference to FIG. 8.

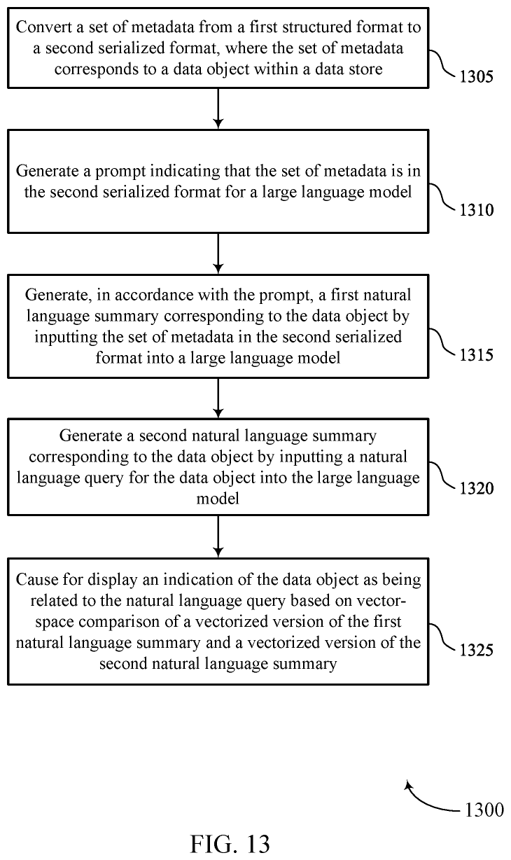

FIG. 13 shows a flowchart illustrating a method 1300 that supports semantic searching of structured data using generated summaries in accordance with aspects of the present disclosure. The operations of the method 1300 may be implemented by a data processor or its components as described herein. For example, the operations of the method 1300 may be performed by a data processor as described with reference to FIGS. 1 through 9. In some examples, a data processor may execute a set of instructions to control the functional elements of the data processor to perform the described functions. Additionally, or alternatively, the data processor may perform aspects of the described functions using special-purpose hardware.

At 1305, the method may include converting a set of metadata from a first structured format to a second serialized format, where the set of metadata corresponds to a data object within a data store. The operations of 1305 may be performed in accordance with examples as disclosed herein. In some examples, aspects of the operations of 1305 may be performed by a metadata component 825 as described with reference to FIG. 8.

At 1310, the method may include generating a prompt indicating that the set of metadata is in the second serialized format for the LLM. The operations of 1310 may be performed in accordance with examples as disclosed herein. In some examples, aspects of the operations of 1310 may be performed by a prompt generation component 855 as described with reference to FIG. 8.

At 1315, the method may include generating, based on the prompt, a first natural language summary corresponding to the data object by inputting the set of metadata in the second serialized format into a LLM. The operations of 1315 may be performed in accordance with examples as disclosed herein. In some examples, aspects of the operations of 1315 may be performed by a summary component 830 as described with reference to FIG. 8.

At 1320, the method may include generating a second natural language summary corresponding to the data object by inputting a natural language query for the data object into the LLM. The operations of 1320 may be performed in accordance with examples as disclosed herein. In some examples, aspects of the operations of 1320 may be performed by a natural language query component 835 as described with reference to FIG. 8.

At 1325, the method may include causing for display an indication of the data object as being related to the natural language query based on vector-space comparison of a vectorized version of the first natural language summary and a vectorized version of the second natural language summary. The operations of 1325 may be performed in accordance with examples as disclosed herein. In some examples, aspects of the operations of 1325 may be performed by a display component 840 as described with reference to FIG. 8.

A method for data processing by an apparatus is described. The method may include converting a set of metadata from a first structured format to a second serialized format, where the set of metadata corresponds to a data object within a data store, generating a first natural language summary corresponding to the data object by inputting the set of metadata in the second serialized format into a LLM, generating a second natural language summary corresponding to the data object by inputting a natural language query for the data object into the LLM, and causing for display an indication of the data object as being related to the natural language query based on vector-space comparison of a vectorized version of the first natural language summary and a vectorized version of the second natural language summary.

An apparatus for data processing is described. The apparatus may include one or more memories storing processor executable code, and one or more processors coupled with the one or more memories. The one or more processors may individually or collectively be operable to execute the code to cause the apparatus to convert a set of metadata from a first structured format to a second serialized format, where the set of metadata corresponds to a data object within a data store, generate a first natural language summary corresponding to the data object by inputting the set of metadata in the second serialized format into a LLM, generate a second natural language summary corresponding to the data object by inputting a natural language query for the data object into the LLM, and cause for display an indication of the data object as being related to the natural language query based on vector-space comparison of a vectorized version of the first natural language summary and a vectorized version of the second natural language summary.

Another apparatus for data processing is described. The apparatus may include means for converting a set of metadata from a first structured format to a second serialized format, where the set of metadata corresponds to a data object within a data store, means for generating a first natural language summary corresponding to the data object by inputting the set of metadata in the second serialized format into a LLM, means for generating a second natural language summary corresponding to the data object by inputting a natural language query for the data object into the LLM, and means for causing for display an indication of the data object as being related to the natural language query based on vector-space comparison of a vectorized version of the first natural language summary and a vectorized version of the second natural language summary.

A non-transitory computer-readable medium storing code for data processing is described. The code may include instructions executable by one or more processors to convert a set of metadata from a first structured format to a second serialized format, where the set of metadata corresponds to a data object within a data store, generate a first natural language summary corresponding to the data object by inputting the set of metadata in the second serialized format into a LLM, generate a second natural language summary corresponding to the data object by inputting a natural language query for the data object into the LLM, and cause for display an indication of the data object as being related to the natural language query based on vector-space comparison of a vectorized version of the first natural language summary and a vectorized version of the second natural language summary.

Some examples of the method, apparatus, and non-transitory computer-readable medium described herein may further include operations, features, means, or instructions for generating the vectorized version of the first natural language summary and the vectorized version of the second natural language summary using an embedding model.

In some examples of the method, apparatus, and non-transitory computer-readable medium described herein, causing for display the indication of the data object may include operations, features, means, or instructions for performing the vector-space comparison based on measuring a distance between the vectorized version of the first natural language summary and the vectorized version of the second natural language summary.

In some examples of the method, apparatus, and non-transitory computer-readable medium described herein, performing the vector-space comparison may include operations, features, means, or instructions for performing a ranking procedure to rank a set of multiple vector distances.

In some examples of the method, apparatus, and non-transitory computer-readable medium described herein, generating the first natural language summary may include operations, features, means, or instructions for generating a prompt indicating that the set of metadata may be in the second serialized format for the LLM, where the first natural language summary may be generated in accordance with the prompt.

Some examples of the method, apparatus, and non-transitory computer-readable medium described herein may further include operations, features, means, or instructions for storing the vectorized version of the first natural language summary in a vector database.

In some examples of the method, apparatus, and non-transitory computer-readable medium described herein, the second natural language summary corresponds to a hypothetical data object related to the natural language query.

In some examples of the method, apparatus, and non-transitory computer-readable medium described herein, the set of metadata in the first structured format indicates a set of multiple attributes associated with the data object.

Some examples of the method, apparatus, and non-transitory computer-readable medium described herein may further include operations, features, means, or instructions for generating the first natural language summary may be based on the set of multiple attributes.

In some examples of the method, apparatus, and non-transitory computer-readable medium described herein, the data object includes structured data in tabular form.

The following provides an overview of aspects of the present disclosure:

Aspect 1: A method for data processing, comprising: converting a set of metadata from a first structured format to a second serialized format, wherein the set of metadata corresponds to a data object within a data store; generating a first natural language summary corresponding to the data object by inputting the set of metadata in the second serialized format into a LLM; generating a second natural language summary corresponding to the data object by inputting a natural language query for the data object into the LLM; and causing for display an indication of the data object as being related to the natural language query based at least in part on vector-space comparison of a vectorized version of the first natural language summary and a vectorized version of the second natural language summary.

Aspect 2: The method of aspect 1, further comprising: generating the vectorized version of the first natural language summary and the vectorized version of the second natural language summary using an embedding model.

Aspect 3: The method of any of aspects 1 through 2, wherein causing for display the indication of the data object further comprises: performing the vector-space comparison based at least in part on measuring a distance between the vectorized version of the first natural language summary and the vectorized version of the second natural language summary.

Aspect 4: The method of aspect 3, wherein performing the vector-space comparison further comprises: performing a ranking procedure to rank a plurality of vector distances.

Aspect 5: The method of any of aspects 1 through 4, wherein generating the first natural language summary further comprises: generating a prompt indicating that the set of metadata is in the second serialized format for the LLM, wherein the first natural language summary is generated in accordance with the prompt.

Aspect 6: The method of any of aspects 1 through 5, further comprising: storing the vectorized version of the first natural language summary in a vector database.

Aspect 7: The method of any of aspects 1 through 6, wherein the second natural language summary corresponds to a hypothetical data object related to the natural language query.

Aspect 8: The method of any of aspects 1 through 7, wherein the set of metadata in the first structured format indicates a plurality of attributes associated with the data object.

Aspect 9: The method of aspect 8, wherein generating the first natural language summary is based at least in part on the plurality of attributes.

Aspect 10: The method of any of aspects 1 through 9, wherein the data object comprises structured data in tabular form.

Aspect 11: An apparatus for data processing, comprising one or more memories storing processor-executable code, and one or more processors coupled with the one or more memories and individually or collectively operable to execute the code to cause the apparatus to perform a method of any of aspects 1 through 10.

Aspect 12: An apparatus for data processing, comprising at least one means for performing a method of any of aspects 1 through 10.

Aspect 13: A non-transitory computer-readable medium storing code for data processing, the code comprising instructions executable by one or more processors to perform a method of any of aspects 1 through 10.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for data processing, comprising:
converting a set of metadata from a first structured format to a second serialized format, wherein the set of metadata corresponds to a data object within a data store;
generating a first natural language summary corresponding to the data object by inputting the set of metadata in the second serialized format into a LLM;
generating a second natural language summary corresponding to the data object by inputting a natural language query for the data object into the LLM; and
causing for display an indication of the data object as being related to the natural language query based at least in part on vector-space comparison of a vectorized version of the first natural language summary and a vectorized version of the second natural language summary.

2. The method of claim 1, further comprising:
generating the vectorized version of the first natural language summary and the vectorized version of the second natural language summary using an embedding model.

3. The method of claim 1, wherein causing for display the indication of the data object further comprises:
performing the vector-space comparison based at least in part on measuring a distance between the vectorized version of the first natural language summary and the vectorized version of the second natural language summary.

4. The method of claim 3, wherein performing the vector-space comparison further comprises:
performing a ranking procedure to rank a plurality of vector distances.

5. The method of claim 1, wherein generating the first natural language summary further comprises:
generating a prompt indicating that the set of metadata is in the second serialized format for the LLM, wherein the first natural language summary is generated in accordance with the prompt.

6. The method of claim 1, further comprising:
storing the vectorized version of the first natural language summary in a vector database.

7. The method of claim 1, wherein the second natural language summary corresponds to a hypothetical data object related to the natural language query.

8. The method of claim 1, wherein the set of metadata in the first structured format indicates a plurality of attributes associated with the data object.

9. The method of claim 8, wherein generating the first natural language summary is based at least in part on the plurality of attributes.

10. The method of claim 1, wherein the data object comprises structured data in tabular form.

11. An apparatus for data processing, comprising:
one or more memories storing processor-executable code; and
one or more processors coupled with the one or more memories and individually or collectively operable to execute the code to cause the apparatus to:
convert a set of metadata from a first structured format to a second serialized format, wherein the set of metadata corresponds to a data object within a data store;
generate a first natural language summary corresponding to the data object by inputting the set of metadata in the second serialized format into a LLM;
generate a second natural language summary corresponding to the data object by inputting a natural language query for the data object into the LLM; and
cause for display an indication of the data object as being related to the natural language query based at least in part on vector-space comparison of a vectorized version of the first natural language summary and a vectorized version of the second natural language summary.

12. The apparatus of claim 11, wherein the one or more processors are individually or collectively further operable to execute the code to cause the apparatus to:
generate the vectorized version of the first natural language summary and the vectorized version of the second natural language summary using an embedding model.

13. The apparatus of claim 11, wherein, to cause for display the indication of the data object, the one or more processors are individually or collectively further operable to execute the code to cause the apparatus to:
perform the vector-space comparison based at least in part on measuring a distance between the vectorized version of the first natural language summary and the vectorized version of the second natural language summary.

14. The apparatus of claim 13, wherein, to perform the vector-space comparison, the one or more processors are individually or collectively further operable to execute the code to cause the apparatus to:
perform a ranking procedure to rank a plurality of vector distances.

15. The apparatus of claim 11, wherein, to generate the first natural language summary, the one or more processors are individually or collectively further operable to execute the code to cause the apparatus to:
generate a prompt indicating that the set of metadata is in the second serialized format for the LLM, wherein the first natural language summary is generated in accordance with the prompt.

16. The apparatus of claim 11, wherein the one or more processors are individually or collectively further operable to execute the code to cause the apparatus to:
store the vectorized version of the first natural language summary in a vector database.

17. The apparatus of claim 11, wherein the second natural language summary corresponds to a hypothetical data object related to the natural language query.

18. The apparatus of claim 11, wherein the set of metadata in the first structured format indicates a plurality of attributes associated with the data object.

19. The apparatus of claim 18, wherein generating the first natural language summary is based at least in part on the plurality of attributes.

20. A non-transitory computer-readable medium storing code for data processing, the code comprising instructions executable by one or more processors to:
convert a set of metadata from a first structured format to a second serialized format, wherein the set of metadata corresponds to a data object within a data store;
generate a first natural language summary corresponding to the data object by inputting the set of metadata in the second serialized format into a LLM;
generate a second natural language summary corresponding to the data object by inputting a natural language query for the data object into the LLM; and
cause for display an indication of the data object as being related to the natural language query based at least in part on vector-space comparison of a vectorized version of the first natural language summary and a vectorized version of the second natural language summary.
